(19) United States
(12) Patent Application Publication
(10) Pub. No.: US 2013/0268584 A1
(43) Pub. Date: Oct. 10, 2013

(54) Methods and apparatus for publishing and subscribing electronic documents using intermediate rendezvous servers

(71) Applicant: Arun Raghavendra Desai, Hayward, CA (US)

(72) Inventor: Arun Raghavendra Desai, Hayward, CA (US)

(21) Appl. No.: 13/856,357

(22) Filed: Apr. 3, 2013

Related U.S. Application Data
(60) Provisional application No. 61/621,547, filed on Apr. 8, 2012.

(51) Int. Cl. H04L 29/06

(52) U.S. Cl. CPC H04L 29/06047
USPC 709/203

(57) ABSTRACT

A system and method for interconnecting a plurality of resource publisher computers with a plurality of rendezvous servers, facilitating resource publishers to dynamically publish content with little or no configuration, further facilitating web based access to the published resources by clients through a rendezvous server. The system organizes users as owners, publishers and/or subscribers of virtual channels, allowing publishers to dynamically publish resource sets to channels, and subscribers to access and/or update resources published to such channels. Resource sets reside at resource publishers, with a rendezvous server facilitating a network path to the resources, enabling resource publishers to have full control over their resources. The system facilitates subscriber clients to connect to a rendezvous server to view the status of the resource sets and access and/or update online resource sets.

### CROSS-REFERENCE

This application refers to the provisional patent application No. 61/621,547 dated 2012 Apr. 8.

### BACKGROUND OF THE INVENTION

In a typical communication between a web browser and a web server, a network entity designed for serving web pages or files implements a server program that accepts incoming network connections, such that clients or browsers connect to the server's network service port. In such a scenario the server opens a passive listening port (e.g. TCP port number 80 for incoming HTTP connections or TCP port number 443 for incoming HTTPS connections) and clients connect to the server by actively connecting to the server's listening port.

In a typical communication between a web browser and a web server through a web proxy, the network traffic between a client and a server is intercepted by an intermediate web proxy. A web proxy is a network entity designed to function as a server to clients and as a client to servers. From the client's point of view, a proxy acts as a server to receive incoming connections from clients. From the server's point of view, it acts as a client by forwarding the incoming connections to the server. A typical set of proxies add value to a network service by load balancing network traffic to the server and/or by off-loading server load by serving locally cached data to clients.

A firewall is a network entity that is typically placed at the entry/exit point of a computer network as a protection device, and can be configured to allow/disallow network connections based on connection attributes. For instance, a firewall can be placed at the entry point of a server farm or data center and it could be configured to let incoming connections destined to the server's TCP port 80 (IANA Internet Assigned Numbers Authority's default HTTP port) to transit through the firewall to the server, whilst dropping incoming connection packets that are unwanted (for example connections with destination port not equal to 80). Another wide spread use of a firewall is at the entry/exit point of small residential networks. For instance, firewall functionality usually comes built-in with home routers used in multitude of human residences. The default role of a home firewall is to disallow incoming network connections whilst allowing outgoing network connections. Such a setup prevents rogue hackers from crafting network attacks on home networks. If a residential user intends to accept incoming connections for a server then the firewall would have to be configured to allow incoming connections for that particular listening port (e.g. TCP protocol port 80).

One of the current methods uses direct peer to peer connections, wherein a residential computer serves files to users over the interne by running a network server program to listen to incoming requests. This solution may or may not allow a peer to browse the remote peer (hereby termed ‘live browsing’). This solution has the following four disadvantages:
a. The peer that serves files has to configure a firewall to allow incoming connections,
b. The peer that serves files has to run a program that listens to incoming connections, thereby opening it up to the possibility of various attacks, such as port scanning, denial of service, and hacking, from anyone on the internet,
c. The peer that accesses (or browses) the files connects to the IP address of the serving peer, requiring it to ‘trust’ that it is connected to the correct IP address, and that the IP addresses has not been spoofed,
d. The peer that accesses (or browses) the files has to rely on the provider's implementation of algorithms for security of the data that travels such connections, given that a web browser will not display the familiar SSL security padlock.

One of the current methods uses server assisted peer to peer connections, wherein peers locate each other's location or IP address using an intermediate server, after which the connections are established in a direct peer to peer mode as above. This method will have the same disadvantages as mentioned in the direct peer to peer case above.

One of the current methods uses cloud storage based file sharing, wherein one peer uploads files to an intermediate server for storage, and an accessing-peer downloads from the intermediate server, a typical scenario being a server supplied program that downloads it automatically to the peer's computer. Methods similar to these are currently implemented by various online sites. While these services overcome the disadvantages of a peer to peer network, they still do not solve the ‘live browsing’ feature, and they require their users to store user files at the service provider. There is a subset of users who do not wish to relinquish their data to a service provider's storage farm.

There is a need for a solution that overcomes all the disadvantages of a peer to peer network, and does not require a user to upload their data to a storage farm, and still maintains the advantages of live browsing. The present invention solves this problem by using secure (SSL based) connections, which ensures DNS security, IP address security, Data Security, Live Browsing, without the need to upload files, while providing a secure browsing experience over HTTPS (Secure HTTP protocol).

The following is a list of items describing how the present invention differs from other inventions:
1) While U.S. Pat. No. 7,161,947 by the current inventor describes a method of transparently intercepting protocols such as FTP that utilize control and data connections; in contrast, the present invention describes a method of serving a protocol such as HTTP that utilizes one connection per request in a manner such that both the accessing computer and serving computer set up active connections to an intermediate rendezvous server.
2) While patent application Ser. No. 11/871,032 describes a method of sharing computer display screens; in contrast, the present invention describes a method for sharing file folders.
3) While patent application Ser. No. 13/644,659 describes a method of integration between local and remote computing environments for the purpose of sharing remote application; in contrast, the present invention describes a method for sharing file folders and for serving files from remote computers.
4) Patent application Ser. No. 13/595,472 describes a method for mobile devices to negotiate a dynamic rendezvous point using a notification, thereby creating a set of ephemeral rendezvous points.
Such a method would require connection initiation from a first mobile device for each rendezvous with a second mobile device. Furthermore, such a method would imply that a rendezvous point is negotiated for each transfer. Furthermore, such a method would imply that the first mobile device and the second mobile device negotiate a rendezvous point sporadically on an as-needed basis. Furthermore, such a method would imply that such transfers occur in a non-continuous form, wherein even during two consecutive transfers there would a small time window (during negotiation) where the first mobile device is unavailable.
In contrast, the present invention describes a method for continuously serving files and folders from a publisher computer utilizing a rendezvous server, using a control connection and a data connection, such that the control connection always remains connected to a rendezvous server, and data requests are handled using a combination of control and data connections, such that data transfer between the publisher and the rendezvous server occurs using a separate data connection. In the present invention, all the clients utilizing the system connect to a well-known server and browse web pages as though it is served from the rendezvous server, such that publisher computers act as a pseudo servers that serve content for channels through the rendezvous server. Furthermore, in the present invention, published data and associated channels are continuously available for the life of the control connection, such that publisher data is available online for extended periods of time, as long as the publisher program stays connected to the rendezvous server (typically for tens of thousands of requests over many days or weeks).

### SUMMARY OF THE INVENTION

In the context of this document, for the purposes of computer networking the use of the term ‘rendezvous’ is meant to imply a network location where the user of a resource and the publisher of a resource meet up by connecting over network connections, such that the user can locate the publisher and the publisher can serve the user with a representation of the resource.

The present invention organizes users as owners, publishers and/or subscribers of virtual channels; wherein requested URLs (Uniform Resource Locators) contain a channel identifier and resource identifier as part of the URL; additionally organizing publishers to dynamically publish resource sets to channels, and subscribers to access and/or update resources published to such channels. For the purpose of this document, the term ‘resource’ implies collected bits of computer data.

The present invention organizes and allows desktop computers and other mobile devices to register as resource publishers with a rendezvous server in the Internet by actively connecting to the rendezvous server (hereby termed ‘control connection’); such that client users (using web browsers) can fetch or update the content residing on a resource publisher by connecting to the rendezvous server (hereby termed ‘subscriber connection’), wherein the rendezvous server forwards the user's request over a control connection to the resource publisher, and the resource publisher in turn sends a content response over an active network connection (hereby termed ‘data connection’) to the rendezvous server, which in turn forwards it to the user over the subscriber connection. Additionally, a publisher control connection is kept open across multiple data connections (from the same publisher), such that it handles multiple subscriber requests, such that published data is available online continuously for the life of the control connection.

As described above, a rendezvous server listens for incoming connections from resource publishers as well as from requesting resource subscriber clients, and it patches the connections together for request and response flows. Thus allowing for content to be served from resource publishers without needing resource publishers to open passive listening ports on resource publisher computers.

A key difference between the present invention and a generic proxy based solution is that in the present invention the publisher actively connects to a rendezvous server, as opposed passively listening for incoming connections, making it firewall friendly, and enabling easy deployment at a multitude of residential customers.

A key difference between the present invention and a peer to peer file sharing network is that the present invention uses standard secure protocol (HTTPS), is not open to IP spoofing, is not open to DNS spoofing, does not open a publisher to attacks from the internet.

A key difference between the present invention and a cloud storage based sharing network is that the present invention allows live browsing of published files without requiring the files to be uploaded and stored at a service provider's server.

Such a scheme, therefore, allows for the arrangement of a multitude of resource publishers connected to a set of distributed rendezvous servers, wherein the content resides at various resource publishers, without requiring the content to be placed in a remote data center, or so called cloud of computer servers.

Additionally, such an arrangement when used for digitally encrypted secure connections, would require Public Key Infrastructure (PKI) digital security certificates (SSL certificates) to be installed only at rendezvous servers instead of at each resource publisher, thereby simplifying the security architecture of the arrangement.

Such a scheme, allows maximum control of the content by a resource publisher by ensuring that bits of private data are not placed on huge computers in a data center or server cloud, whilst providing a dynamic control over the availability and unavailability of content.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, with the emphasis instead being placed upon illustrating the embodiments, principles and concepts of the invention.

FIG. 1 is a block diagram of a rendezvous server based data communications system, configured according to one embodiment of the invention.

FIG. 2 is a flow chart of the process of a request and response flow at a rendezvous server of the data communications system, when the system is configured as per FIG. 1.

FIG. 3 is a block diagram of the modules of a rendezvous server, configured according to one embodiment of the invention.

### DETAILED DESCRIPTION OF THE EMBODIMENTS

The present invention relates to techniques for arranging resource publishers and rendezvous servers to provide a dynamically controllable resource publication system that is accessible over the interne without the need to set up full scale servers at the various resource publishers. A typical server on the Internet requires a valid domain name, a firewall for protection, and a host of other supporting networking gear. The present invention allows resource publishers to publish resources like software files and directories by simply registering with a rendezvous server, without the need for additional networking gear. The present invention also provides security of the resources at a resource publisher by actively connecting to a rendezvous server, as opposed to passively listening to incoming connections.

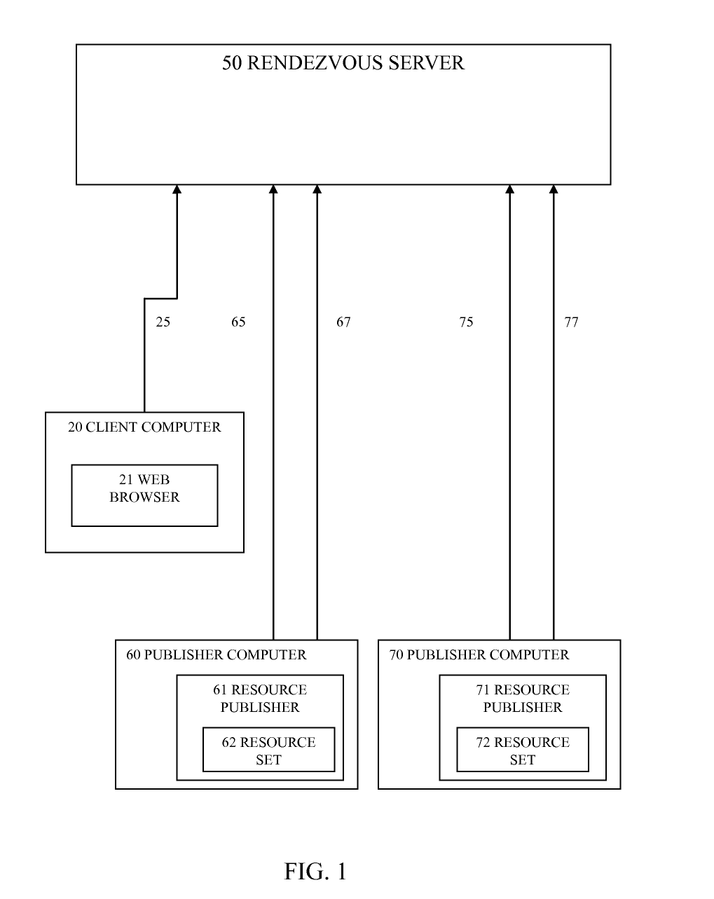

FIG. 1 shows a data communications system configured to operate according to the principles of this invention. The data communications system includes a first computerized device, such as client computer 20, a computer server device 50, a second computerized device, such as publisher computer 60, a third computerized device, such as publisher computer 70. The direction of arrows in FIG. 1 indicate the direction in which a connection is initiated, such that the arrowhead is at the listener end of a TCP connection.

As illustrated in FIG. 1, during a typical operation of the data communications system, the user operating the client computer 20 uses a web browser 21 to connect to the rendezvous server 50. The rendezvous server shows the online or offline status of the various resource publishers that the user has authority to access. If a resource publisher is offline, the user cannot access or browse the associated resources or files.

Publisher computer 60 can initiate a network connection, hereby termed ‘control connection’ 65 to the rendezvous server 50. By doing so it registers with the rendezvous server 50, after which point the status of the resource publisher changes to ‘online’.

Publisher computer 70 can initiate a network connection, hereby termed ‘control connection’ 75 to the rendezvous server 50. By doing so it registers with the rendezvous server 50, after which point the status of the resource publisher changes to ‘online’.

If the user has access rights to the resource set 62 published by the publisher computer 60, the user can access or update the resources in resource set 62.

If the user does not have access rights to the resource set 72 published by the publisher computer 70, the rendezvous server 50 does not allow the user to access the resources in resource set 72.

Access rights to resource sets can be implemented in various ways. The method described in this invention implements access rights by associating various resource sets to virtual channels, wherein users who are subscribers of certain channels can access those resources, and users who are publishers of certain channels can publish resource sets to those channels.

After receiving the HTTP request from web browser 21 over subscriber connection 25 to read a resource belonging to resource set 62; if the user has access rights to that set, the rendezvous server 50 forwards the request to the resource publisher 61 over control connection 65. The resource publisher 61 generates a response and sends the resource (e.g. software copy of a file) to the rendezvous server 50 over data connection 67. The rendezvous server 50 in turn forwards the response to the web browser 21 over subscriber connection 25.

After receiving the HTTP request from web browser 21 over subscriber connection 25 to read a resource belonging to resource set 72; if the user does not have access rights to that set, the rendezvous server 50 rejects the request by sending an error response to the web browser 21 over subscriber connection 25.

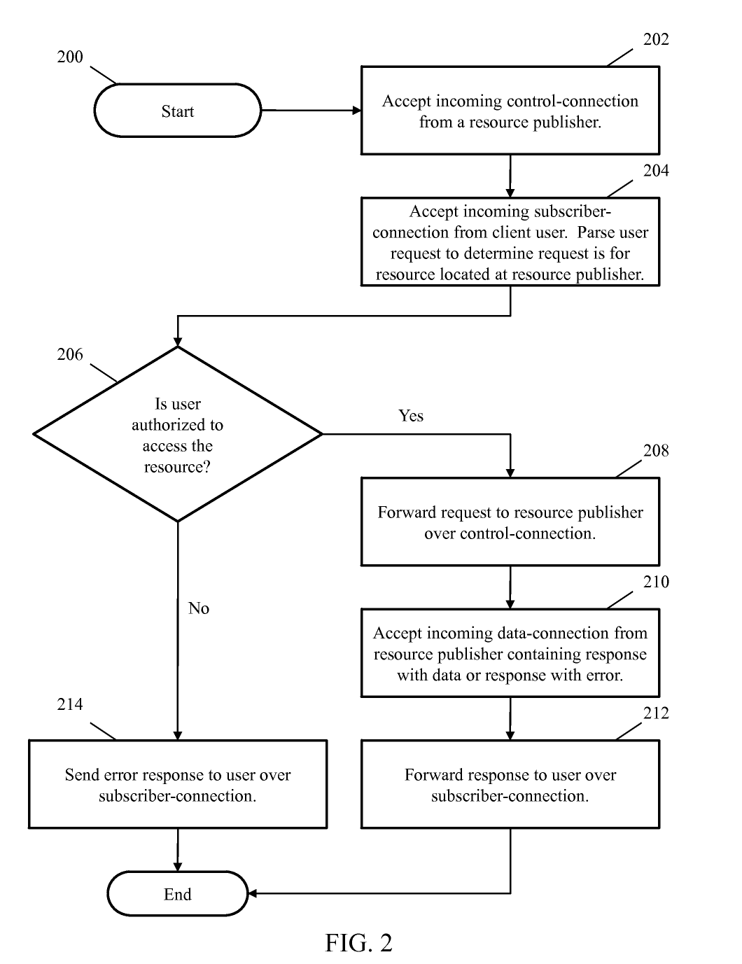

FIG. 2 illustrates a procedure 200 for managing connections at a rendezvous server for a request from a client user, such as web browser 21, for a resource located at a publisher computer such as 70.

In step 202, the rendezvous server receives a control connection request from the publisher computer 70. The rendezvous server accepts the connection and adds connection information about resource publisher 71 to its software registry.

In step 204, the rendezvous server receives a request from the client web browser 21 over subscriber connection 25. The rendezvous server accepts the connection and parses the request to find that it is a request to fetch a resource located at the publisher computer 70 in the resource set 72 which can be served by the resource publisher 71.

In step 206, the rendezvous server consults a channel publish-subscribe module to check whether the user is authorized to access the resource. If the user is authorized to access the aforementioned resource the rendezvous server proceeds to step 208, else it proceeds to step 214.

In step 208, the rendezvous server forwards the subscriber request to the resource publisher 71 over control connection 75.

In step 210, the rendezvous server accepts an incoming data connection 77 from the resource publisher 71 containing a response. A response can contain either a successful result with associated data or an error result with associated error information.

In step 212, the rendezvous server forwards the response to the client web browser 21 over the subscriber connection 25.

In step 214, the rendezvous server forwards an authorization failure error response to the client web browser 21 over the subscriber connection 25.

In a related embodiment, the rendezvous server can allocate a specific time interval for receiving a response from the resource publisher 71. In case a response is not received within the specified time interval, the rendezvous server can abort the request processing and send an error response to the client web browser 21 over the subscriber connection 25.

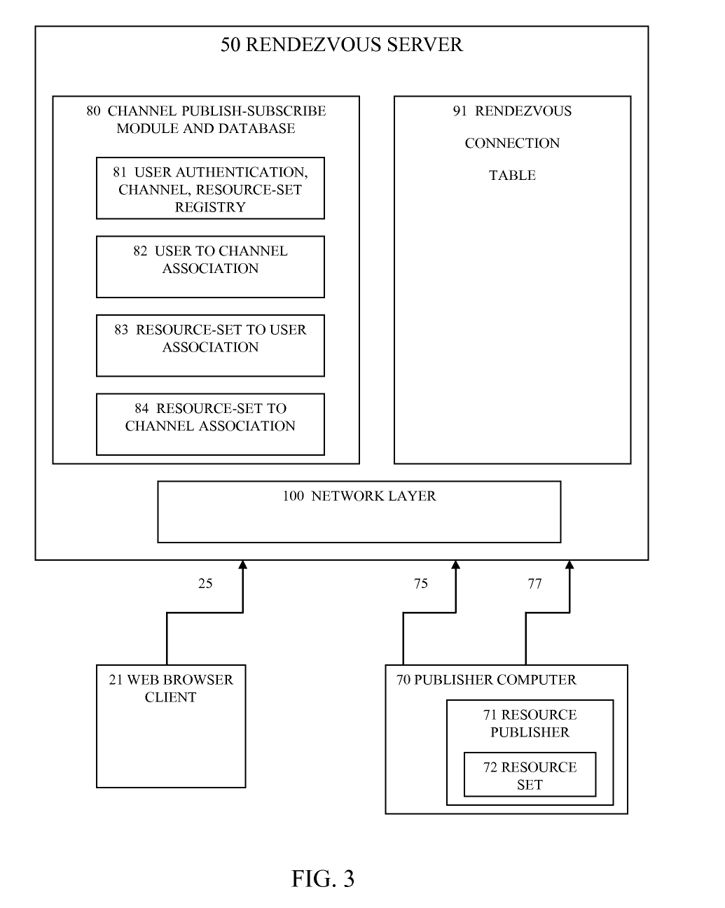

FIG. 3 shows a block diagram of a rendezvous server 50 configured according to one embodiment of the invention. The server system includes a database 80 hereby termed ‘channel publish-subscribe module’ for storing various association tables, such as registry 81 for storing user authentication, channel, and resource-set entries, user to channel associations 82, resource-set to user associations 83, resource-set to channel associations 84; a rendezvous connection table 91; a network layer 100 to accept incoming network connections such as subscriber connection 25, control connection 75, data connection 77. FIG. 3 also depicts publisher computer 70 and web browser 21 which are external to the rendezvous server. The direction of arrows in FIG. 3 indicate the direction in which a connection is initiated, such that the arrowhead is at the listener end of a TCP connection.

The rendezvous server 50 receives an incoming control connection 75 from a resource publisher user at the network layer 100, upon which it validates the user by checking the registry 81. It further checks if the user is a channel publisher by searching the user to channel association 82. It further checks if there are any published resource-sets by the user by searching the resource-set to channel association 83. If all these checks succeed an entry is added to the rendezvous connection table 91, else the control connection is rejected.

The rendezvous server 50 receives a request over an incoming subscriber connection 25 from a subscriber user using a web browser client 21 at the network layer 100, upon which it validates the user by checking the registry 81. It further checks if the user is allowed to access the requested channel by searching the user to channel association 82. It further searches the rendezvous connection table 91 to locate a resource publisher control connection 75 associated with the requested channel, upon which it forwards the request along with a unique request identifier to resource publisher 71 over control connection 75. It further adds a uniquely identifiable entry to the rendezvous connection table 91 for subscriber connection 25.

The rendezvous server 50 receives an incoming data connection 77 from resource publisher 71 at the network layer 100, upon which it searches the rendezvous connection table 91 to find the uniquely identified entry for subscriber connection 25. If the request on subscriber connection 25 has a data payload it forwards it to the publisher over the data connection 77. Additionally, it forwards the response received on data connection 77 to the user over subscriber connection 25.

In a related embodiment, publisher control connections, publisher data connections, and subscriber connections use encrypted network service, such as SSL (Secure Sockets Layer), further ensuring security of the data.

In a related embodiment, the subscriber connection request is for storing data to the publisher's resource-set (e.g. an HTTP POST request), wherein data payload of a request is forwarded to the resource publisher over the data connection and stored in the resource-set at the publisher. Such a configuration can be used to dynamically update the resource set mapped to the channel. Furthermore, such a configuration can be used to distribute data to multiple channel users across multiple computers.

In a related embodiment, a publisher computer has one resource publisher, but multiple resource sets, such that one resource set is available on one channel, whereas a second resource set is available on a different channel. In such a scenario, the rendezvous server checks whether the client web browser is allowed access to the specific channel before forwarding the request to the resource publisher.

In a related embodiment, resource publishers are full scale servers located within a network of computers equipped to safely handle incoming traffic, wherein resource publishers dynamically publish content by utilizing a rendezvous server as a means for redirecting client traffic to the appropriate resource publisher. Such a configuration can be deployed for high performance content publishing.

In a related embodiment, multiple full scale servers with duplicate data are set up as resource publishers connected as slave servers to a main rendezvous server. Such a configuration can be used for a high redundancy web service or for load balancing web content.

In a related embodiment, multiple full scale servers with differing data are set up as resource publishers connected as slave servers to a main rendezvous server. Such a configuration can be used across geographic regions, wherein various regional resource publishers feed into a centralized rendezvous server. Such a configuration can be used for deploying a content aggregation system.

In a related embodiment, multiple rendezvous servers are set up within a server cluster, such that they load balance incoming publisher and subscriber connections based on the connection load of the cluster.

In a related embodiment, multiple rendezvous servers are set up across geographically diverse locations, such that publishers are assigned to a rendezvous server based on the proximity of the publisher with the rendezvous server.

It is to be understood that the above-described embodiments are simply illustrative of the principles of the invention. Various and other modifications and changes may be made by those skilled in the art which will embody the principles of the invention and fall within the spirit of and scope thereof.

What is claimed is:

1. In a rendezvous server, a method for receiving a request over an incoming subscriber connection from a resource subscriber computer, pairing it with incoming control and data connections from a resource publisher computer, and forwarding a subscriber request and associated publisher response comprising the steps of:
receiving incoming control connection from resource publisher;
authenticating and associating resource publisher connection;
receiving request over incoming subscriber connection from resource subscriber;
authenticating and associating resource subscriber request;
forwarding subscriber request to associated publisher;
receiving incoming data connection from resource publisher;
associating response on publisher data connection to subscriber request;
forwarding any additional request data and response between associated subscriber and publisher.

2. The method of claim 1 wherein the step of receiving a incoming control connection from resource publisher comprises the step of accepting an incoming control connection from a resource publisher for the purpose of serving requests on all virtual channels owned by a particular resource publisher user.

3. The method of claim 1 wherein the step of authenticating and associating resource publisher connection comprises the steps of:
validating the authenticity of the resource publisher by querying an authentication database;
associating the resource publisher to all virtual channels owned by a particular resource publisher user.

4. The method of claim 1 wherein the step of receiving a request over an incoming subscriber connection from resource subscriber comprises the step of receiving an incoming subscriber connection containing a request to access or update a resource belonging to a virtual channel.

5. The method of claim 1 wherein the step of authenticating and associating resource subscriber request comprises the steps of:
validating the authenticity of the resource subscriber by querying an authentication database;
associating the request to a virtual channel, thereby associating it to a resource publisher of that virtual channel.

6. The method of claim 1 wherein the step of forwarding subscriber request to associated publisher comprises the steps of reading a request from a subscriber connection and forwarding the request to a resource publisher over a publisher control connection.

7. The method of claim 1 wherein the step of receiving incoming data connection from resource publisher comprises the step of accepting an incoming data connection from a resource publisher that contains a matching response for an outstanding subscriber request.

8. The method of claim 1 wherein the step of associating response on publisher data connection to subscriber request comprises the step of associating a response received on a publisher data connection to a particular subscriber request.

9. The method of claim 1 wherein the step of forwarding any additional request data and response between associated subscriber and publisher comprises the steps of:
forwarding any additional request data received along with the request on the subscriber connection to the associated publisher over the publisher data connection;
forwarding the response received on the publisher data connection to the associated subscriber connection;
inserting error codes in the response, if needed.

10. The method of claim 1 wherein a publisher control connection is kept open across multiple data connections (from the same publisher), such that it handles multiple subscriber requests, such that published data is available online continuously for the life of the control connection.

11. A server device comprising of:
at least one communications interface;
a processor;
a memory;
and an interconnection mechanism coupling the at least one communication interface, the processor, and the memory;
wherein the server device is configured to:
receive control connections from publishers at a fixed port;
receive data connections from publishers at a fixed port;
receive subscriber connections from subscribers at a fixed port;
receive and send data bits on connections;
maintain a channel publish-subscribe module, which is further configured to maintain a user registry, an authentication database, a channel registry, a resource-set registry, a user to channel association table, a resource-set to channel association table, a resource-set to user association table;
maintain a rendezvous connection table.

12. A resource publisher-subscriber dynamic connection mapping method, comprising the steps of:
dynamically adding an incoming publisher control connection identifier to rendezvous connection table;
dynamically adding an incoming subscriber request identifier to rendezvous connection table;
dynamically adding an incoming publisher data connection identifier to rendezvous connection table;
dynamically pairing a subscriber request identifier with a publisher control connection identifier;
dynamically pairing a subscriber request identifier with a publisher data connection identifier;
transferring request and response data between associated subscriber and publisher;
dynamically removing all connection identifiers and pairings from a rendezvous connection table.

13. The method of claim 12, wherein the connection mapping method is further configured to maintain a rendezvous connection table.

14. The method of claim 12, wherein upon receiving a control connection request from a verifiable resource publisher a channel publisher entry is added to the rendezvous connection table, associating the resource publisher to all channels published by the resource publisher user.

15. The method of claim 12, wherein upon receiving a request over a subscriber connection from a verifiable resource subscriber, a subscriber connection entry along with a unique request key is added to the rendezvous connection table, associating the resource subscriber to the channel, thereby pairing the subscriber with the publisher of the channel.

16. The method of claim 12, wherein a subscriber request along with a request key is forwarded to a resource publisher over a resource publisher control connection.

17. The method of claim 12, wherein a data connection is received from a resource publisher containing a response along with a request key, upon which the data connection is paired with a subscriber connection using the request key.

18. The method of claim 12, wherein:
any additional request data is forwarded from a subscriber connection to an associated publisher data connection;
a response is forwarded from a publisher data connection to a subscriber over an associated subscriber connection.

19. The method of claim 12, wherein a subscriber connection and a data connection are either closed or re-used for a subsequent request.
